(19) United States
(12) Patent Application Publication
(10) Pub. No.: US 2012/0026394 A1
(43) Pub. Date: Feb. 2, 2012

(54) Video Decoder, Decoding Method, and Video Encoder

(76) Inventor: Emi Maruyama, Kunitachi-shi (JP)

(21) Appl. No.: 13/036,487

(22) Filed: Feb. 28, 2011

(30) Foreign Application Priority Data
Jul. 30, 2010 (JP) 2010-172751

(51) Int. Cl. H04N 7/00

(52) U.S. Cl. 348/465; 348/E07.001

(57) ABSTRACT

In one embodiment, there is provided a video decoder. The video decoder includes: a receiver configured to receive data of main images, data of subtitle images, and subtitle time information about display periods of the subtitle images; a decoder configured to decode the data of the main images; a determining module configured to determine first frames among all frames of decoded data of the main images based on the subtitle time information, wherein the subtitle images are displayed on the first frames; and a processor configured to perform image processing on first pixels among all pixels of the first frames, wherein each of the first pixels has a color that belongs to a certain color space range.

### CROSS-REFERENCE TO RELATED APPLICATION

This application claims priority from Japanese Patent Application No. 2010-172751, filed on Jul. 30, 2010, the entire contents of which are hereby incorporated by reference.

### BACKGROUND

1. Field

Embodiments described herein generally relate to a video decoder, a decoding method, and a video encoder.

2. Description of the Related Art

A technique of detecting a skin region of a person appearing in video by detecting colors of pixels of the video is known. In this connection, in a video decoder which decodes encoded video data, it is preferable that video data representing a skin region be decoded with proper image quality by performing image processing on that video data. On the other hand, in a video encoder which encodes video data, it is preferable that video data representing a detected skin region be encoded with proper image quality by assigning a proper amount of codes to that video data.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B show an example use form of a video decoder and a video encoder according to an embodiment and an example data structure of a packet, respectively;

FIG. 2 shows an example system configuration of the video decoder and the video encoder according to the embodiment;

FIG. 3 is a block diagram showing an example functional configuration of the video decoder according to the embodiment;

FIG. 4 shows an example operation of detecting a subtitle period in the video decoder according to the embodiment;

FIG. 5 is a flowchart of a decoding process which is executed by the video decoder according to the embodiment;

FIG. 6 is a block diagram showing an example functional configuration of the video encoder according to the embodiment; and

FIG. 7 is a flowchart of an encoding process which is executed by the video encoder according to the embodiment.

### DETAILED DESCRIPTION

According to exemplary embodiments, there is provided a video decoder. The video decoder includes: a receiver configured to receive data of main images, data of subtitle images, and subtitle time information about display periods of the subtitle images; a decoder configured to decode the data of the main images; a determining module configured to determine first frames among all frames of decoded data of the main images based on the subtitle time information, wherein the subtitle images are displayed on the first frames; and a processor configured to perform image processing on first pixels among all pixels of the first frames, wherein each of the first pixels has a color that belongs to a certain color space range.

An embodiment will be hereinafter described with reference to the drawings.

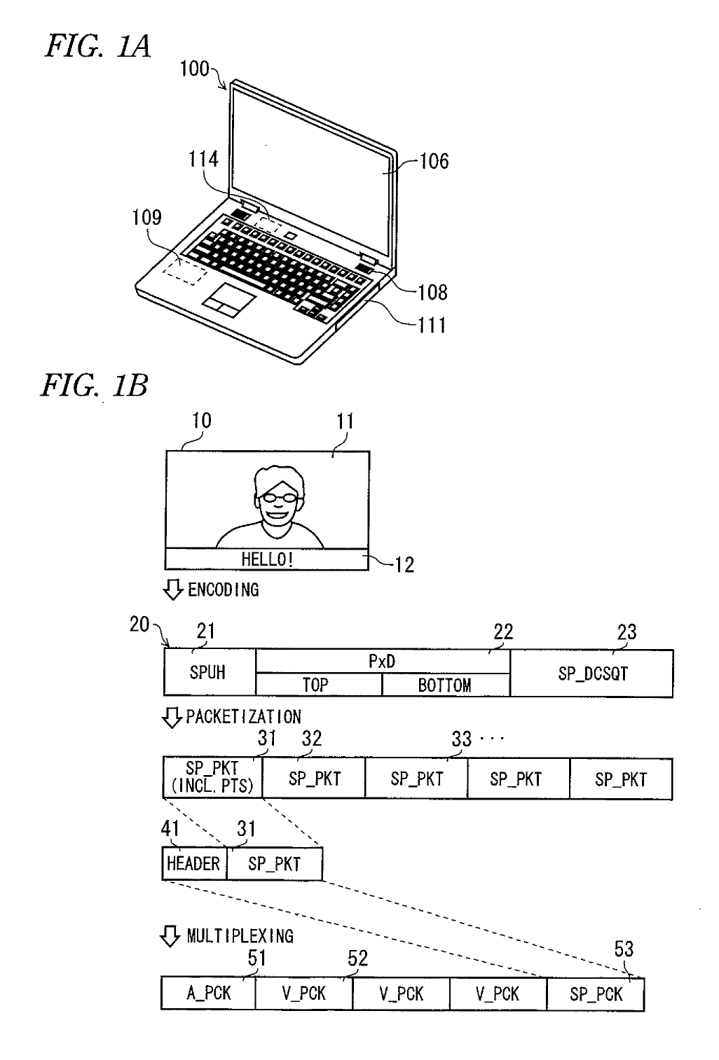

FIG. 1A shows an example use form of a video decoder and a video encoder according to the embodiment, which are implemented as a computer 100. The computer 100 includes an LCD 106, speakers 108, an HDD 109, an ODD 111, a tuner 114, etc.

The computer 100 has a function of decoding, for example, packets of a content received by the tuner 114 or packets of a content read from an optical disc such as a DVD by the ODD 111, displaying video of the packets on the LCD 106, and outputting a sound of the packets from the speakers 108. In doing so, the computer 100 can determine whether or not each frame includes a person based on information about a subtitle display period and pieces of color infatuation of the pixels constituting the frame which are contained in packets of a content.

The computer 100 also has a function of encoding video data contained in decoded packets of a content with image quality that accords with pieces of subtitle time information contained in the packets. The computer 100 also has a function of storing resulting encoded data in the HDD 109 or writing resulting encoded data in a medium such as a DVD with the ODD 111.

FIG. 1B shows an example data structure of a packet used in DVDs etc. For example, in a movie/moving image content stored in a DVD, subtitles are not buried in video and video data and subtitle data are encoded as data of different pictures. More specifically, data of video 11 which is a main image of a frame 10 shown in FIG. 1B and data of a subpicture 12 which is an auxiliary image (subtitle) of the frame 10 are encoded separately.

A subpicture unit 20 which is encoded data of the one-frame subpicture 12 contains SPUR 21, PXD 22, SP_DCSQT 23, etc. The SPUR 21 is header information of the subpicture unit 20, and the PXD 22 is compression-encoded pixel data. The SP_DCSQT 23 is control information relating to display of the subtitle and contains, for example, subtitle display stop information about a time of a stop of display of the subtitle, information about a position (coordinates) of display of the subtitle, etc.

The subpicture unit 20 is packetized according to, for example, MPEG2-PS (program stream) into such packets as SP_PKT 31, SP_PKT 32, SP_PKT 33, etc. The SP_PKT 31 which is a packet containing head data of the subpicture unit 20 is given information about a display start time of the subtitle which is called PTS (presentation time stamp). PTS is given to not only the subpicture packets but also video packets.

Each of the SP_PKTs 31-33 is added with a header 41. A subpicture pack SP_PCK 53 which is given the header 41 is multiplexed with an audio data pack A_PCK 51 and video data pack V_PCK 52, etc.

The computer 100 according to the embodiment can decode video data containing information about a subtitle display time with proper image quality that accords with the information about the subtitle display time.

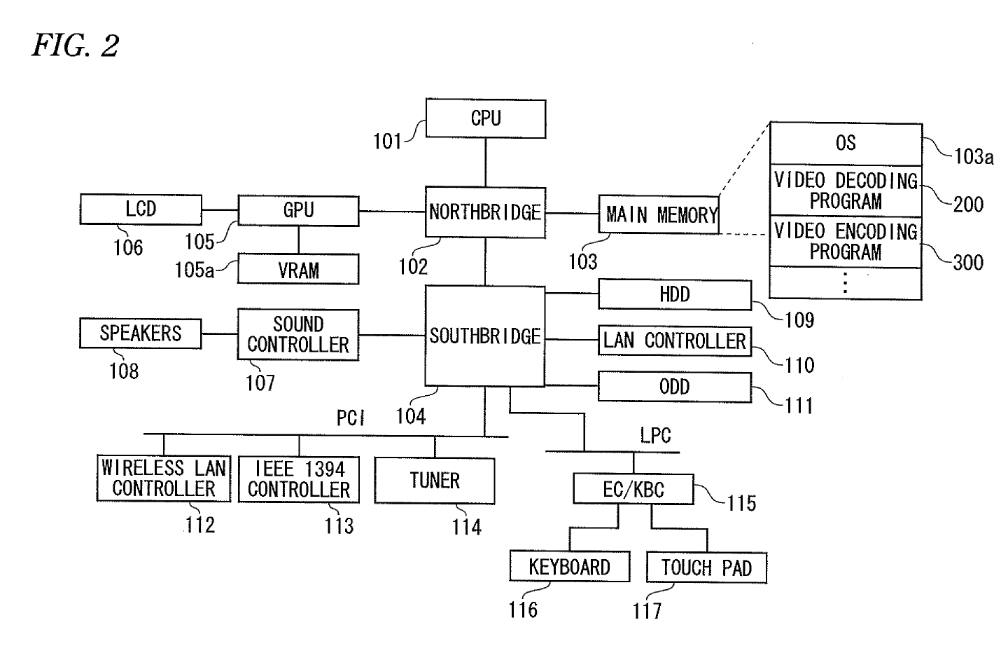

FIG. 2 shows an example system configuration of the moving image video decoder and video encoder according to the embodiment, which are implemented as the computer (personal computer) 100.

The computer 100 includes a CPU 101, a northbridge 102, a main memory 103, a southbridge 104, a graphics processing unit (GPU) 105, a video memory (VRAM) 105a, a sound controller 107, the hard disk drive (HDD) 109, a LAN controller 110, the ODD 111, a wireless LAN controller 112, an IEEE 1394 controller 113, the tuner 114, an embedded controller/keyboard controller IC (EC/KBC) 115, keyboard 116, a touch pad 117, etc.

The CPU 101, which is a processor for controlling operations of the computer 100, runs an operating system (OS) 103a and various application programs such as a video decoding program 200 and a video encoding program 300 when they are loaded into the main memory 103 from the HDD 109.

The video decoding program 200 is a program for decoding encoded moving image data, and the video encoding program 300 is a program for encoding moving image data.

The northbridge 102 is a bridge device for connecting a local bus of the CPU 101 to the south bridge 104. The northbridge 102 incorporates a memory controller for access-controlling the main memory 103. The northbridge 102 also has a function of performing a communication with the GPU 105 via a PCI Express serial bus or the like.

The GPU 105 is a display controller for controlling the LCD 106 which is used as a display monitor of the computer 100. A display signal generated by the GPU 105 is supplied to the LCD 106.

The southbridge 104 controls the individual devices on an LPC (low pin count) bus and the individual devices on a PCI (peripheral component interconnect) bus. The southbridge 104 incorporates an IDE (integrated drive electronics) controller for controlling the HDD 109 and the ODD 111. The southbridge 104 also has a function of performing a communication with the sound controller 107.

The sound controller 107, which is a sound source device, outputs reproduction subject audio data to the speakers 108.

The wireless LAN controller 112 is a wireless communication device for performing a wireless communication according to the IEEE 802.11 standard, for example. The IEEE 1394 controller 113 performs a communication with an external device via an IEEE 1394 serial bus. The tuner 114 has a function of receiving a TV broadcast. The EC/KBC 115 is a one-chip microcomputer in which an embedded controller for power management and a keyboard controller for controlling the keyboard 116 and the touch pad 117 are integrated together.

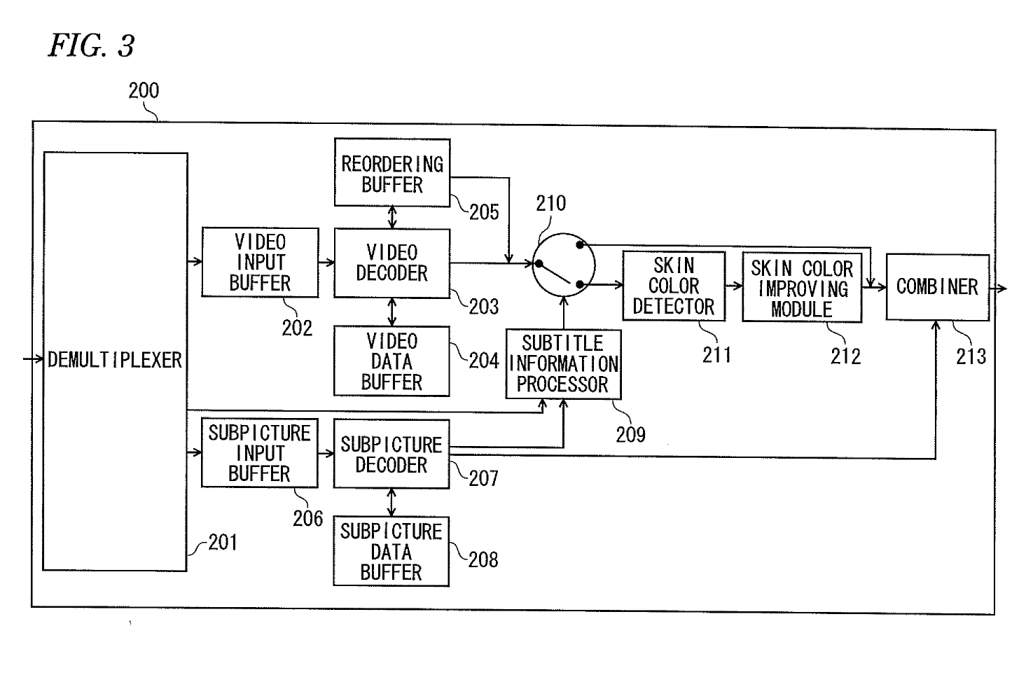

Next, an example functional configuration of a software video decoder which is implemented by the video decoding program 200 which is run by the computer 100 according to the embodiment will be described with reference to FIG. 3.

The video decoding program 200 includes a demultiplexer 201, a video input buffer 202, a video decoder 203, a video data buffer 204, a reordering buffer 205, a subpicture input buffer 206, a subpicture decoder 207, a subpicture data buffer 208, a subtitle information processor 209, a switch 210, a skin color detector 211, a skin color improving module 212, a combiner 213, etc.

A packetized stream of a broadcast content received by the tuner 114, a content read by the ODD 111, or the like is input to the demultiplexer 201. The packetized stream is an MPEG2-PS (program stream), an MPEG2-TS (transport stream), or the like. The demultiplexer 201 analyzes the received stream and separates a video ES (elementary stream), a subpicture ES, and an audio ES from the received stream.

The demultiplexer 201 outputs the separated video ES and subpicture ES to the video input buffer 202 and the subpicture input buffer 206, respectively. The demultiplexer 201 outputs PTS information of each packet to the subtitle information processor 209.

The video ES is input to the video input buffer 202. The video input buffer 202 buffers the received video ES until its decoding timing, and outputs it to the video decoder 203 at its decoding timing.

The video decoder 203 decodes the received video ES into a picture data constructed by pixel data and outputs the picture data to the switch 210. The video data buffer 204 is used as a data buffer area for this decoding processing. The video decoder 203 may generate a first picture data by referring to a second picture data generated by itself and stored the second picture data in the reordering buffer 205.

In this case, the second picture data to be referred to is buffered in the reordering buffer 205 and output to the switch 210 after being referred to by the video decoder 203. On the other hand, a third picture data that is not referred to is output to the switch 210 without being buffered in the reordering buffer 205.

The subpicture ES is input to the subpicture input buffer 206. The subpicture input buffer 206 buffers the received subpicture ES until its decoding timing, and outputs it to the subpicture decoder 207 at its decoding timing.

The subpicture decoder 207 decodes the received subpicture ES into a subpicture and outputs the subpicture to the combiner 213. Furthermore, the subpicture decoder 207 outputs subtitle display stop information contained in the received subpicture ES to the subtitle information processor 209. In decoding one subpicture unit at a time indicated by PTS and outputting a resulting subpicture to the combiner 213, the subpicture decoder 207 buffers the decoded subpicture in the subpicture data buffer 208. The subpicture decoder 207 continues to output the buffered subpicture to the combiner 213 until a subtitle display stop time indicated by subtitle display stop information if it exists or until decoding of the next subpicture unit.

In a use mode in which subpictures are always transmitted even without any subtitles, the subpicture decoder 207 outputs subtitle display stop information to the subtitle information processor 209 upon detection of the fact that a subpicture unit has no pixel data. The subpicture data buffer 208 is used as a data buffer area for this decoding processing.

The subtitle information processor 209 calculates a subtitle display period based on PTS infatuation of each packet received from the demultiplexer 201 and subtitle display stop information received from the subpicture decoder 207. The subtitle information processor 209 determines on what a picture data that is output from the video decoder 203 a subtitle subpicture is to be superimposed for display. The subtitle information processor 209 controls the switch 210 so that it outputs the picture data to be displayed in a subtitle display period to the skin color detector 211 and outputs the picture data not to be displayed in a subtitle display period to the combiner 213.

The switch 210 has a function of outputs the picture data that is input from the video decoder 203 or the reordering buffer 205 to an output destination specified by the subtitle information processor 209. That is, the switch 210 outputs the picture data to be displayed in a subtitle display period to the skin color detector 211 and outputs the picture data not to be displayed in a subtitle display period to the combiner 213 according to an instruction from the subtitle information processor 209.

The skin color detector 211 determines whether or not the color of each pixel of the picture data that is input from the switch 210 belongs to a color space range of a skin color. For example, this is done by determining whether or not the hue of each pixel exists in a range of 0° to 30° in the color space of the HSV model. That is, the skin color detector 211 determines that the color of a pixel belongs to the color space range of the skin color if the hue of the pixel exists in the range of 0° to 30°, and determines that a pixel does not have a skin color if the hue of the pixel does not exist in the range of 0° to 30°. The skin color detector 211 outputs, to the skin color improving module 212, the picture data that is input from the switch 210 and position coordinates information indicating a position coordinates of each pixel whose color belongs to the color space range of the skin color.

The skin color improving module 212 performs image processing on the skin color pixels indicated by the pieces of position coordinates information that are input from the skin color detector 211 among the pixels of the picture data that is input from the skin color detector 211. For example, the skin color improving module 212 performs such kinds of processing as color correction, luminance correction, noise elimination, and image quality enhancement in which human skin characteristics are taken into consideration on the skin color pixels specified by the pieces of position coordinates information. The skin color improving module 212 outputs a resulting picture data to the combiner 213.

The combiner 213 generates a single picture data by superimposing the picture data received from the skin color improving module 212 or the switch 210 and the subpicture received from the subpicture decoder 207 on each other. The combiner 213 outputs the generated picture data to the GPU 105, for example. The output picture data is displayed on a display device such as the LCD 106.

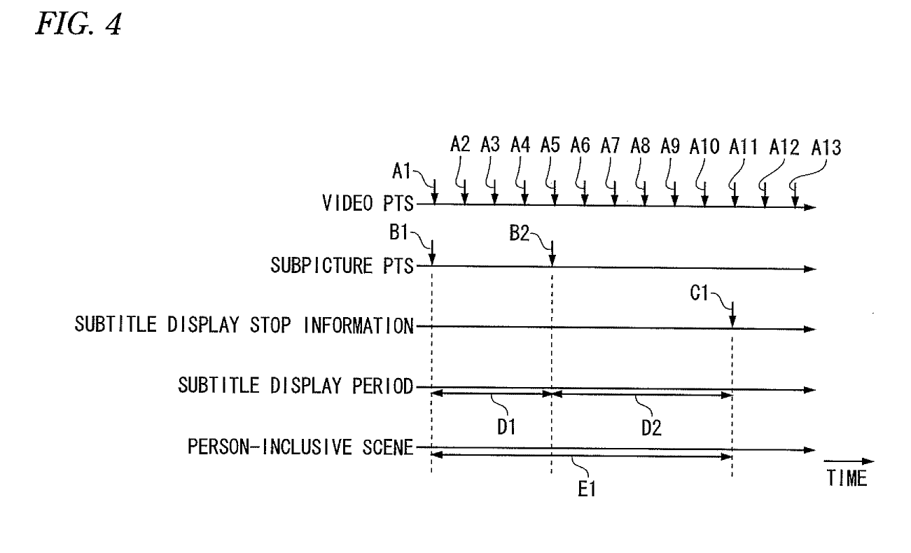

Next, an example operation of the subtitle information processor 209 will be described with reference to FIG. 4.

When detecting PTS of each packet, the demultiplexer 201 output the detected PTS to the subtitle information processor 209. The subpicture decoder 207 outputs subtitle display stop information to the subtitle information processor 209.

Now assume that PTSs of 13 consecutive video packets specify time points A1-A13, that PTSs of two consecutive subpicture packets specify time points B1 and B2, and that the subtitle display stop information specifies a time point C1. Therefore, subtitle display periods are period D1 from time B1 specified by one PTS to time B2 specified by the next PTS and period D2 from time B2 to time C1 specified by the subtitle display stop information.

It is highly probable that a person is to be displayed in a subtitle display period E1. Therefore, the subtitle information processor 209 controls the switch 210 so that it outputs, to the skin color detector 211, a picture data to be displayed in the period E1 of the picture data decoded by the video decoder 203. In this manner, the computer 100 can detect a skin region of a person in each picture with, high accuracy.

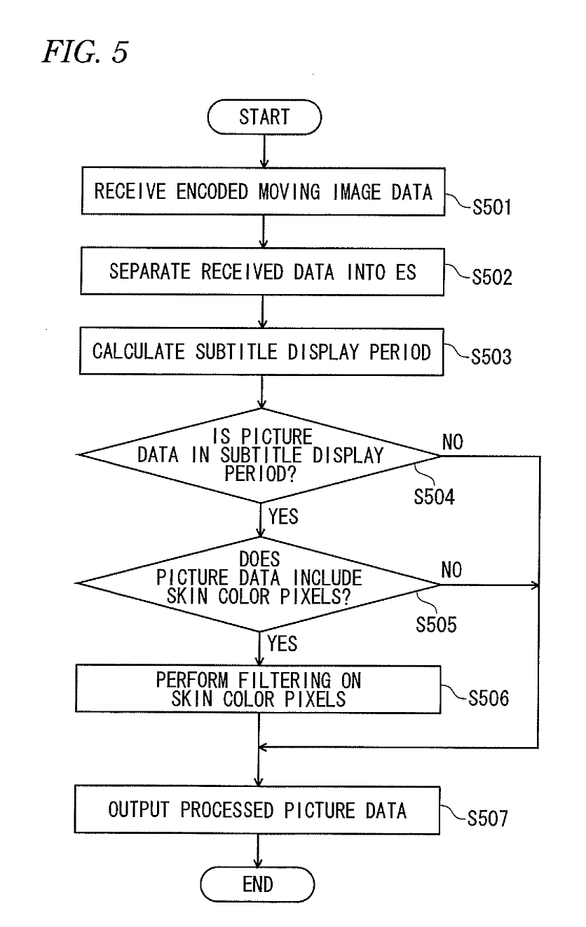

Next, the procedure of an example decoding process which is executed by the video decoding program 200 will be described with reference to FIG. 5.

First, at step S501, packets of encoded moving image data are input to the demultiplexer 201. At step S502, the demultiplexer 201 separates a video ES, a subpicture ES, an audio ES, and other ESs from the received data. At step S503, the subtitle information processor 209 calculates a subtitle display time based on PTSs and subtitle display stop information.

If a picture data that is input to the switch 210 is in a subtitle period (S504: yes), the subtitle information processor 209 controls the switch 210 so that it outputs the received picture data to the skin color detector 211. On the other hand, if the picture data that is not input to the switch 210 is in a subtitle period (S504: no), the subtitle information processor 209 controls the switch 210 so that it outputs the received picture data to the combiner 213.

At step S505, the skin color detector 211 determines whether or not the received picture data includes skin color pixels. If the received picture data includes skin color pixels (S505: yes), the skin color detector 211 outputs the received picture data and position coordinates information indicating a position coordinates of each skin color pixel to the skin color improving module 212.

When receiving the received picture data and the position coordinates information of each skin color pixel of the picture data, at step S506 the skin color improving module 212 performs skin color improving processing such as filtering processing on the skin color pixels of the picture data. More specifically, the skin color improving module 212 performs the skin color improving processing on a pixel of the picture data that has been determined by the subtitle information processor 209 as a picture data where a subtitle is to be displayed if the pixel belongs to the color space range of the skin color, and does not perform the skin color improving processing on pixels that do not belong to the color space range of the skin color.

At step S507, the skin color improving module 212 outputs the picture data that has been subjected to the filtering processing to the combiner 213.

As described above with reference to FIG. 3, the combiner 213 performs processing of superimposing the picture and the subpicture on each other. A resulting single picture is output to the LCD 106 and displayed thereon.

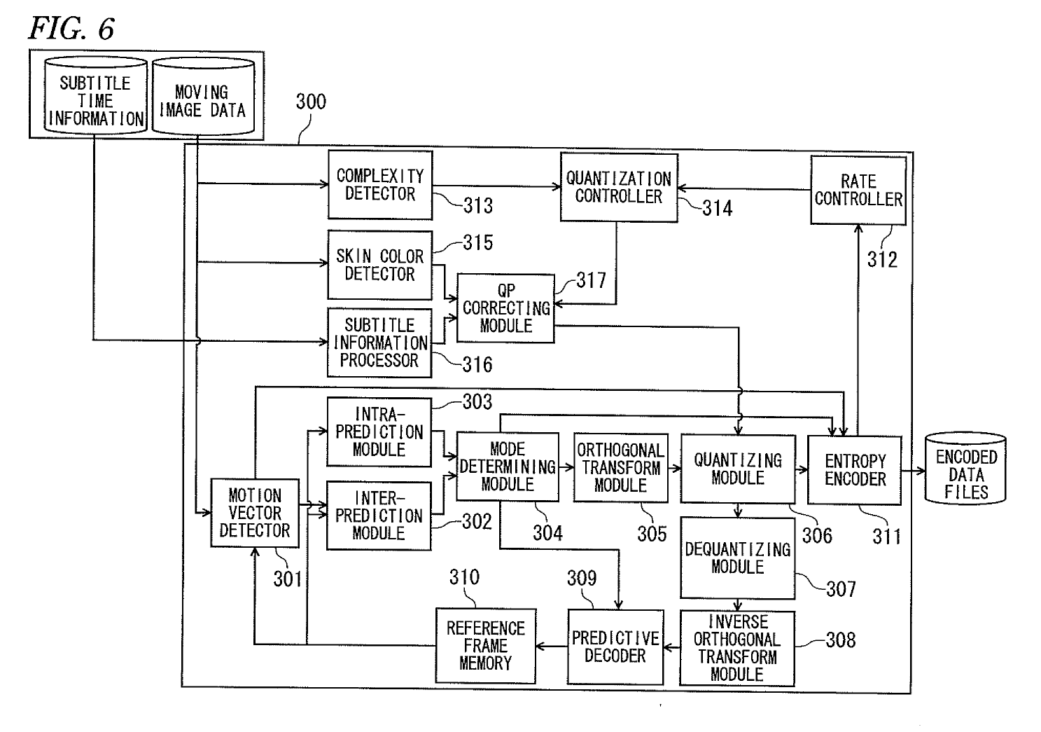

Next, an example functional configuration of a software video encoder which is implemented by the video encoding program 300 which is run by the computer 100 according to the embodiment will be described with reference to FIG. 6.

The video encoding program 300 includes a motion vector detector 301, an inter-prediction module 302, an intra-prediction module 303, a mode determining module 304, an orthogonal transform module 305, a quantizing module 306, a dequantizing module 307, an inverse orthogonal transform module 308, a predictive decoder 309, a reference frame memory 310, an entropy encoder 311, a rate controller 312, a complexity detector 313, a quantization controller 314, a skin color detector 315, a subtitle information processor 316, a quantization parameter (QP) correcting module 317, etc.

An image signal (moving image data) is input to the motion vector detector 301. The image signal is data of a frame that includes pixel blocks obtained by division in units of a macroblock, for example. The motion vector detector 301 calculates a motion vector for each macroblock of the encoding subject input image (input image frame). More specifically, the motion vector detector 301 reads decoded image data stored in the reference frame memory 310 and calculates a motion vector for each macroblock. Then, the motion vector detector 301 determines optimum motion compensation parameters based on the input image and the decoded image data. The motion compensation parameters are a motion vector, a shape of a motion-compensated prediction block, a reference frame selection method, etc.

The inter-prediction module 302 performs inter-frame motion compensation processing. First, the inter-prediction module 302 receives the input image signal and the optimum motion compensation parameters determined by the motion vector detector 301. And the inter-prediction module 302 reads the decoded image data stored in the reference frame memory 310.

The inter-prediction module 302 performs inter-frame amplitude compensation processing on the read-out decoded image data (reference image) by performing multiplication by weight coefficients, addition of an offset, etc. using the motion compensation parameters. Then, the inter-prediction module 302 generates a prediction difference signal for each of a luminance signal and a color difference signal. More specifically, the inter-prediction module 302 generates a prediction signal corresponding to the encoding subject macroblock from the reference image using the motion vector corresponding to the encoding subject macroblock. Then, the inter-prediction module 302 generates a prediction difference signal by subtracting the prediction signal from the image signal of the encoding subject macroblock.

The image signal (moving image data) is input to the intra-prediction module 303. The intra-prediction module 303 reads local decoded image data of an encoded region of the current frame stored in the reference frame memory 310 and performs intra-frame prediction.

The mode determining module 304 receives the respective prediction results of the inter-prediction module 302 and the intra-prediction module 303, and determines a proper prediction mode (encoding mode) capable of lowering the encoding cost, that is, decides on the intra-prediction or the inter-prediction, based on encoding costs calculated from the received results.

The orthogonal transform module 305 calculates orthogonal transform coefficients by performing orthogonal transform processing on the prediction difference signal of the encoding mode determined by the mode determining module 304. The orthogonal transform includes, for example, a discrete cosine transform.

The quantizing module 306 receives the orthgonal transform coefficients calculated by the orthogonal transform module 305 and a quantization parameter that is output from the quantization parameter correcting module 317. Then, the quantizing module 306 calculates quantized orthogonal transform coefficients by performing quantization processing on the orthogonal transform coefficients that are output from the orthogonal transform module 305.

The dequantizing module 307, the inverse orthogonal transform module 308, and the predictive decoder 309 calculates a decoded image signal by decoding the quantized orthogonal transform coefficients and stores the decoded image signal in the reference frame memory 310.

More specifically, the dequantizing module 307 calculates orthogonal transform coefficients by performing dequantization processing on the quantized orthogonal transform coefficients. The inverse orthogonal transform module 308 calculates a difference signal by performing inverse orthogonal transform processing on the orthogonal transform coefficients. The predictive decoder 309 generates a decoded image signal based on the difference signal and information of the encoding mode received from the mode determining module 304.

That is, the dequantizing module 307, the inverse orthogonal transform module 308, and the predictive decoder 309 perform decoding processing on the quantized orthogonal transform coefficients generated from the input bit stream and a resulting decoded image signal is stored in the reference frame memory 310 so as to be used for encoding processing. The decoded image signal stored in the reference frame memory 310 is used as a reference frame for motion-compensated prediction.

The entropy encoder 311 performs entropy encoding processing (variable-length encoding, arithmetic encoding, or the like) on the quantized orthogonal transform coefficients calculated by the quantizing module 306. The entropy encoder 311 also performs entropy encoding processing on the encoding information such as the motion vector. The entropy encoder 311 outputs together the quantized orthogonal transform coefficients and the encoding information as subjected to the entropy encoding processing.

The rate controller 312 calculates an information amount of encoded data (generated code amount) for each frame using the encoded data generated by the entropy encoder 311. The rate controller 312 performs rate control processing by a feedback control based on the calculated information amount of encoded data of each frame. More specifically, the rate controller 312 sets a quantization parameter for each frame based on the calculated information amount of encoded data of the frame. The rate controller 312 outputs the thus-set quantization parameter to the quantization controller 314.

The image signal (moving image data) is input to the complexity calculating module 313 in units of a macroblock. The complexity calculating module 313 calculates an activity value indicating image complexity for each macroblock based on, for example, a variance of the input image signal.

The quantization controller 314 adjusts, on a macroblock-by-macroblock basis, the quantization parameter of each frame received from the rate controller 312 based on the complexity of each pixel block (macroblock) calculated by the complexity calculating module 313. For example, the quantization controller 314 increases the quantization parameter of a macroblock having the same position coordinates as a pixel block having a large activity value, and decreases the quantization parameter of a macroblock having the same position coordinates as a pixel block having a small activity value.

That means compression distortion and image quality degradation are less prone to be conspicuous in a complex pixel block having a large activity value, and the code amount may be decreased by increasing the quantization parameter. Conversely, for a flat pixel block having a small activity value where compression distortion and image quality degradation are more prone to be conspicuous, the quantization parameter may be decreased.

The image signal (moving image data) is input to the skin color detector 315 in units of a pixel block (macroblock). The skin color detector 315 detects, for each macroblock, whether or not the pixels of each pixel block (macroblock) belong to the color space range of the skin color. For example, this is done by determining whether or not the hue of each pixel exists in a range of 0° to 30° in the color space of the HSV system. That is, the skin color detector 315 determines that the color of a pixel block belongs to the color space range of the skin color if the hue of the pixel block exists in the range of 0° to 30°, and determines that the color of a pixel block does not belong to the color space range of the skin color if the hue of the pixel does not exist in the range of 0° to 30°.

Pieces of subtitle time information about subtitle display periods of the moving image that is input to the video encoding program 300 are input to the subtitle information processor 316. The subtitle information processor 316 determines whether or not each pixel block (macroblock) that is input to the skin color detector 315 is included in a frame having a subtitle based on associated subtitle time information. The subtitle time information indicates a period when a subtitle is to be displayed in the form of information indicating in what frame of the moving image a subtitle is included, information indicating in what period of the moving image a subtitle is to be displayed, or like information. That is, the subtitle time information indicates a period when a subtitle is to be displayed in each frame.

The quantization parameter (QP) correcting module 317 corrects the quantization parameter received from the quantization controller 314 according to the judgment results of the skin color detector 315 and the subtitle information processor 316. The quantization parameter correcting module 317 decreases the quantization parameter for a macroblock whose color belongs to the color space range of the skin color and that has the same position coordinates as a pixel block that is included in a frame where a caption is to be displayed.

This is because it is highly probable that a skin color region of a frame where a subtitle is to be displayed is a region of a human skin and encoding can be performed so as to suppress image quality degradation of a skin region by correcting the quantization parameter in the skin region so as to decrease it. The quantization parameter correcting module 317 outputs a corrected quantization parameter to the quantizing module 306.

On the other hand, the quantization parameter correcting module 317 outputs the quantization parameter to the quantizing module 306 without correcting it for a macroblock whose color does not belong to the color space range of the skin color or a macroblock that has the same position coordinates as a pixel block that is not included in a frame where a caption is to be displayed.

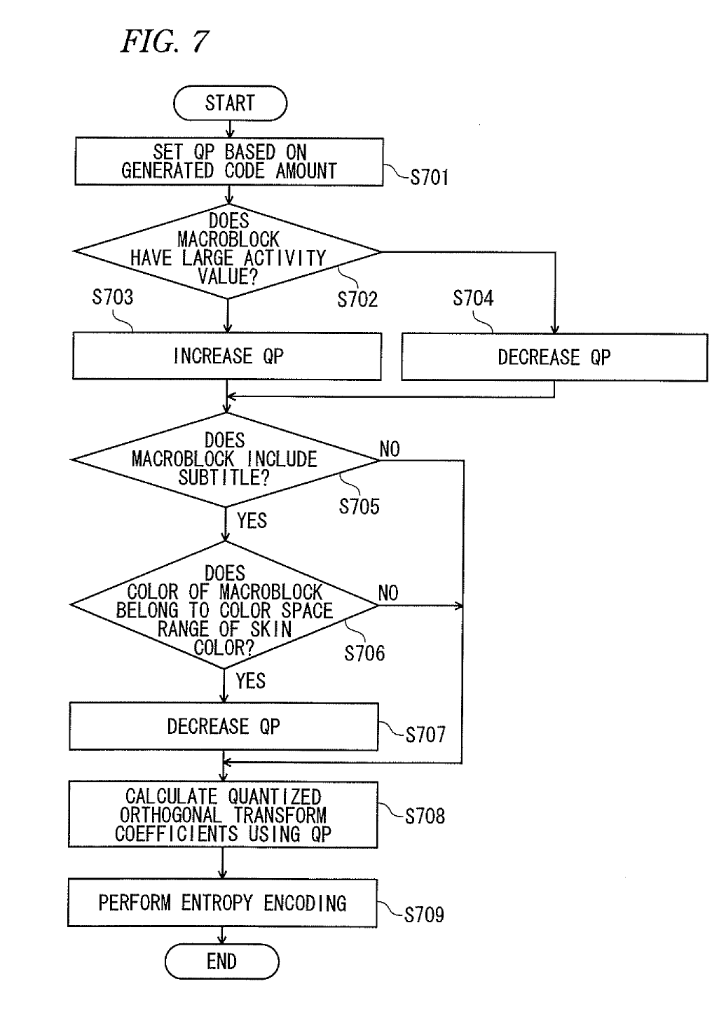

Next, the procedure of an example encoding process which is executed by the video encoding program 300 will be described with reference to FIG. 7.

First, at step S701, the rate controller 312 calculates an information amount of encoded data (generated code amount) of each frame using encoded data that has been generated by the entropy encoder 311. Then, the rate controller 312 sets a quantization parameter for each frame based on the calculated generated code amount.

Then, the complexity detector 313 calculates an activity value of each pixel block (macroblock), and the quantization controller 314 adjusts the quantization parameter set by the rate controller 312 according to the calculated activity value. More specifically, if the pixel block has a large activity value (S702: yes), at step S703 the quantization controller 314 adjusts the quantization parameter of a macroblock having the same position coordinates as the pixel block so as to increase it. On the other hand, if the pixel block has a small activity value (S702: no), at step S704 the quantization controller 314 adjusts the quantization parameter of a macroblock having the same position coordinates as the pixel block so as to decrease it. That is, the quantization controller 314 adjusts the quantization parameter according to the activity value which indicates complexity of a pixel block.

At step S705, the subtitle information processor 316 determines whether or not a frame including the pixel block is a frame in which a subtitle is to be displayed. At step S706, the skin color detector 315 determines, for each macroblock, whether or not the color of the image signal belongs to the color space range of the skin color. If the pixel block is included in a frame having a subtitle (S705: yes) and the color of the image signal belongs to the color space range of the skin color (706: yes), at step S707 the quantization parameter correcting module 317 corrects the quantization parameter as adjusted by the quantization controller 314 so as to decrease it in a macroblock having the same position coordinates as the pixel block. The quantization parameter correcting module 317 outputs a corrected quantization parameter to the quantization module 306. On the other hand, if the pixel block is not included in a frame having a subtitle (S705: no) or the color of the pixel block does not belong to the color space range of the skin color (S706: no), the quantization parameter correcting module 317 outputs quantization parameter as adjusted by the quantization controller 314 to the quantization module 306 without correcting it.

At step S708, the quantizing module 306 calculates quantized orthogonal transform coefficients by quantizing orthogonal transform coefficients as calculated by the orthogonal transform module 305 using the quantization parameter that is input from the quantization parameter correcting module 317. At step S709, the entropy encoder 311 performs entropy encoding processing on the calculated quantized orthogonal transform coefficients.

That is, if the subtitle information processor 316 determines that a pixel block (macroblock) is included in a frame where a subtitle is to be displayed, the entropy encoder 311 can encode the quantized orthogonal transform coefficients located at a position corresponding to the position of the macroblock by assigning, to the macroblock, a code amount that depends on whether or not the skin color detector 315 determines that the pixel block (macroblock) includes skin color pixels. The entropy encoder 311 can encode a pixel block with the code amount that accords with an activity value of the pixel block detected by the complexity detector 313.

Although in the example of FIGS. 6 and 7 the computer 100 performs various kinds of processing in units of a macroblock, the invention is not limited to such a case. For example, the computer 100 performs various kinds of processing in units of a sub-macroblock or a range that is neither a macroblock nor a sub-macroblock.

The computer 100 according to the embodiment can lower the probability of erroneous detection of a human skin region. The computer 100 can display a good image to the user by performing image processing on a detected skin region. Furthermore, the computer 100 can generate encoded data in which a human skin region is given high image quality because a larger code amount can be assigned to the human skin region.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and split of the invention.

What is claimed is:

1. A video decoder comprising:
a receiver configured to receive data of main images, data of subtitle images, and subtitle time information about display periods of the subtitle images;
a decoder configured to decode the data of the main images;
a determining module configured to determine first frames among all frames of decoded data of the main images based on the subtitle time information, wherein the subtitle images are displayed on the first frames; and
a processor configured to perform image processing on first pixels among all pixels of the first frames, wherein each of the first pixels has a color that belongs to a certain color space range.

2. The video decoder of claim 1,
wherein the subtitle time information includes:
display start time points of the subtitle images; and
display stop time points of the subtitle images, and
wherein the determining module is configured to determine the first frames based on the display start time points and the display stop time points.

3. The video decoder of claim 1,
wherein when the data of the subtitle images include pixel data, the processor is configured to perform the image processing on the first pixels, and
wherein when the data of the subtitle images do not include the pixel data, the processor is configured not to perform the image processing on the first pixels.

4. The video decoder of claim 3,
wherein the receiver is configured to receive information about display start time points of the subtitle images,
wherein the decoder is configured to decode the data of the subtitle images not including the pixel data,
wherein the determining module is configured to determine second frames among all frames of the decoded data of the main images, based on the information about the display start time points and time points when the decoder decodes the data of the subtitle images not including the pixel data, wherein the subtitle images containing the pixel data are displayed on the second frames, and
wherein the processor is configured to perform image processing on second pixels among all pixels of the second frames, wherein each of the second pixels has a color that belongs to the certain color space range.

5. The video decoder of claim 1, further comprising:
a display device configured to display video including frames subjected to the image processing.

6. A decoding method comprising:
receiving data of main images, data of subtitle images, and subtitle time information about display periods of the subtitle images;
decoding the data of the received main images;
determining first frames among all frames of decoded data of the main images based on the subtitle time information, wherein the subtitle images are displayed on the first frames; and
performing image processing on first pixels among all pixels of the first frames, wherein each of the first pixels has a color that belongs to a certain color space range.

7. A video encoder comprising:
a receiver configured to receive data of frames and subtitle time information about periods when subtitles are displayed in the frames, wherein each of the frames includes pixel blocks that are divided by a macroblock unit;
a first determining module configured to determine whether each of the pixel blocks is included in a frame including a subtitle, based on the subtitle time information;
a second determining module configured to determine whether each of the pixel blocks includes a pixel having a color that belongs to a certain color space range;
an assigning module configured to assign an encode amount to the pixel block, depending on whether the pixel block includes a pixel having a color that belongs to the certain color space range, if the first determining module determines that the pixel block is included in the frame including the subtitle; and
an encoder configured to encode the pixel block with the encode amount.

8. The video encoder of claim 7, further comprising:
a detector configured to detect complexity of each of the pixel blocks,
wherein the assigning module is configured to assign the encode amount to the pixel block depending on the complexity of the pixel block.
